(19) United States
(12) Patent Application Publication
(10) Pub. No.: US 2009/0038011 A1
(43) Pub. Date: Feb. 5, 2009

(54) SYSTEM AND METHOD OF IDENTIFYING AND REMOVING MALWARE ON A COMPUTER SYSTEM

(75) Inventor: Baskar S. Nadathur, Singapore (SG)

Correspondence Address: DICKSTEIN SHAPIRO LLP, 1177 AVENUE OF THE AMERICAS (6TH AVENUE), NEW YORK, NY, 10036-2714, US

(73) Assignee: Rudra Technologies Pte Ltd., Singapore (SG)

(21) Appl. No.: 11/577,969

(22) PCT Filed: Oct. 19, 2005
(86) PCT No.: PCT/US05/37539

§ 371 Date: Sep. 7, 2007

Related U.S. Application Data
(60) Provisional application No. 60/622,272, filed on Oct. 26, 2004.

(51) Int. Cl. G06F 21/00; G06F 12/00; G06F 12/02; G06F 3/048

(52) U.S. Cl. 726/24; 707/205; 707/200; 715/770

(57) ABSTRACT

A system and accompanying method of identifying and removing malware on a computer system is disclosed. The system comprises a source file containing reference attributes and properties of components of a local computer system in a state unaffected by malware, and exact copies of the system control files. The components of the local computer system may comprise executable and script files such as operating system files, application programs, system controls, registry files and all other executable and script files and their related relevant files. Current status of executables are checked against the reference attributes. All executables on local computer system failing certain match criteria are removed from the local system, or alternatively, replaced with reference copies from source file. Thereby, the system and method identifies malware based on previous system state, method of entry into the local computer system, and intention to automatically execute either upon booting or upon launching of a computer program which a user has intentionally installed and which the user would normally believe to be free of malware.

### CROSS REFERENCE TO RELATED APPLICATIONS

This application is a continuation of U.S. Provisional Application Ser. No. 60/622,272 the entirety of which is incorporated herein by reference.

### BRIEF DESCRIPTION OF THE INVENTION

The present invention relates generally to computer security. More particularly, the present invention relates to protecting computer systems from malware, including computer viruses.

### BACKGROUND

Malicious software (“malware”) is software designed specifically to damage or disrupt a system, such as a virus or a Trojan. Existing technology used to detect and repair computer systems from malware currently comprise either a signature-based or a heuristic logic methodology. Signature-based technology is ineffective when dealing with new viruses since the signature of a new virus remains unknown until it is trapped by an antivirus software company, analyzed and its signature found and incorporated into a software patch. Heuristic logic methodology characterizes the execution pattern or behavior of files. Heuristic logic methods carry only a probability of success and do not provide trouble free identification and elimination of new viruses. A further drawback of heuristic logic methodology is a potential treatment of benign executable code and script as malware, resulting in probability of quarantining or removal of essential executable files.

With the Internet and other networking platforms enabling global and mass communication, the rate at which a new virus can infect computers is exceedingly high since most computers are connected to a network, such as the World Wide Web, leading to a very large number of computers across the world being damaged. What is needed is an anti-malware approach that does not rely on virus signatures or on heuristic logic and yet provides a certainty of 1) identifying new malware and 2) eliminating the responsible malware from the computer system.

### SUMMARY OF THE INVENTION

In accordance with the aforementioned needs and shortcomings in the prior art, a system and method for identification and removal of malware is disclosed. As used herein, the indefinite article “a” or “an” and the phrase “at least one” shall be considered, where applicable, to include within its meaning the singular and the plural, that is, “one or more”. The system comprises a source file containing attributes and properties of components of a local computer system, the local computer system in a state unaffected by malware. The components of the local computer system may comprise operating system files, application programs, system controls, registry files and all other executable and script files and their related relevant files. Upon boot the system continually references executable and script files on the local computer system with the source file. Similarly, the system can monitor “On Access”, i.e. by identifying all files that are being saved in the hard disk during as the saving occurs, and applying the same rules to determine whether the said file is malicious or not, and if determined to be malicious to remove the file, as is described herein.

The system removes executable and script files subsequent to comparison to the source file upon satisfaction of removal criteria by those files. The removal criteria may include method of entry of software into the local computer system, with the intention that the software will automatically execute either upon booting or upon launching of a computer program which the user has intentionally installed and which the user would normally believe to be free of malware. A method of entry of the software into the computer system without the knowledge and intention of the user would be interpreted as stealth entry. The criteria for the intention will be deemed to be met when the software is installed in the hard disk in such a manner as to execute automatically, e.g., without any specific user action for the sole purpose of launching this software, such as automatic execution upon booting or automatic execution upon launching of other software, etc. A combination of stealth entry and said intention would satisfy removal criteria. Satisfaction of at least one criteria, e.g., either stealth entry or intention criteria alone, would qualify for removal treatment with prior approval from the user. Files created in the computer system without the explicit knowledge of the user, as long as they have been created in the system by a process which has been validated by the user, shall not be deemed to be of stealth entry, and as they have been caused by a validated process, shall not be deemed, as unintended (i.e., as meeting intention criteria), such as, for example, in the case of an user-validated automatic online update of the Windows Operating System files.

A method for identification and removal of malware from a local computer comprises storing information about the local computer state in a source file, comparing executable files and their components with the source file, and removing executable files that do not have a corresponding and identical fingerprint in the source file is also disclosed. Executable file, as used herein, comprises its broadest meaning and includes the whole executable file, properties that distinguish or identify the file as an executable file, or shortcuts to launch the executable files. For example, reference made to scanning the executable file may refer to reading the entirety of the executable file or simply scanning the executable file for the properties included in it.

The present invention provides a system for identifying and removing malicious software from a computer system including a processor and memory comprising: a storage medium comprising an executable file, a detection module, and a removal criterion, wherein said detection module is configured to remove the executable file if the detection module determines that the executable file meets the removal criterion. The executable file can be operatively connected to a related component program; and the detection module can be configured to remove the executable file and the related component program if the detection module determines that the executable file meets the removal criterion. The system can further comprise a quarantine folder, wherein the executable file is removed to the quarantine folder if the executable file meets the removal criterion. The computer system can further comprise: a handheld computer device, a laptop computer device, a cell-phone, a personal digital assistant; or a desktop computer.

The system can comprise a source file comprising stored file information identifying a malware-free state of said computer system. The stored file information may comprise a stored copy of a malware-free executable file, which may further be on a remote storage device. The stored file information may comprises a fingerprint including information about a malware-free execution file. The detection module can compare the executable file with the stored file information to determine if the executable file meets the removal criterion; and removes the executable file that meets the removal criteria.

The removal criterion can comprise removing the executable file when said executable file does not correspond to the stored information. The removal criterion can comprise removing the executable file when said executable file is configured to automatically execute without user approval, and may further comprise requiring confirmation before removing the executable file. The system's removal criterion can comprise removing the executable file, said executable file being operatively related to an instruction to automatically launch the executable file and the system's detection module is can be configured to read said system's files for the instruction to automatically launch the executable file, said system's files including system control files and configuration files.

The detection module can be configured to scan the executable file and send a pass signal to the system if said executable file matches the stored filed information. A pass signal can be sent if said executable file property matches the fingerprint. A pass signal can be sent if the executable file matches a stored copy of the malware-free executable file. The detection module can continue to scanning the executable files in a storage medium until all executable files are referenced against said fingerprint in said source file.

The system can further comprise a process filter, said process filter configured to prevent the executable file from launching to a Random Access Memory if said executable file does not correspond to the stored information.

The system can further comprise a pre-validation criterion, wherein the executable file meeting the pre-validation criterion will not be subject to removal via the removal criteria. The pre-validation criterion can comprise: the executable file is a function of an automatic update. The pre-validation criterion can comprise: the executable file is effected as a function of user activity. The user activity can comprise a user function, the user function comprising any one or more of: a cut and paste function, a copy and paste function, a drag and drop function, a send to function, a save as faction, a setup function, a rename file function, and an editing function.

The invention provides a method for identifying and removing malware from a computer system comprising: storing information about a state of a computer system, said state being free of malware; detecting an executable file in said computer system; comparing the executable file with the stored information; determining if the executable file matches the stored information; sending a pass signal if said executable file matches the corresponding stored information; and removing said executable file when said executable file does not match the corresponding stored information. Malware can include a virus that launches automatically upon a launch of the executable file.

The removing can comprise removing the executable to a quarantine folder. The stored information can comprise a fingerprint, said fingerprint including identifying information about malware-free execution files. The fingerprint can include a plurality of fingerprints.

The stored information can include copies of a malware-free executable file in a storage medium. The method can the further include comparing the executable file with the stored information; determining, via the detection module, whether there is any difference between the executable file and the stored information; and if there is the difference, replacing said removed executable file with the copy of the stored malware-free executable file.

The method's detecting can comprise any one or more of: continuous monitoring of FAT configuration, recursive searching using scanning of the local computer system hard disk, searching for an event trigger upon saving a file to a storage medium of the computer system; and tracking a computer log. The detecting can further comprise updating the state of a local computer system, the state being free of malware. The detecting can also comprise determining if the executable files are configured to execute automatically. The method can comprise indicating that new software is to be installed on the computer system; and
a) accepting an executable file that is not identical to the stored information as a function of the indication, if said executable file not configured to execute automatically; or
b) accepting a removal confirmation prior to removing an executable file if said file is configured to execute automatically.

The method's comparing the executable file can further comprise: comparing a file attribute, said file attribute comprising one or more of: a respective file size, a file path, a file creation time, and a file name. The method's removing can comprise: removing the executable file when the file was not created intentionally by a user; and notifying the user via a notification output that the file was removed as malware. The method can further comprise repeating the comparing until all executable files are compared to the fingerprints.

The method's detecting can further comprise: detecting an executable file operatively connected to a related component program in said computer system, determining if the executable file and the related component program matches said stored information, sending a pass signal if said executable file and the related component program has the corresponding stored information, and removing said executable file and the related component program when said executable file does not have the corresponding stored information.

The method can comprise preventing the executable file from launching to a Random Access Memory if said executable file property does not correspond to the fingerprint in the source file. The method can also comprise pre-validating the executable file such that it will not be subject to removal via the removal criteria. The pre-validating comprises pre-validating the executable file as a function of an automatic update. The pre-validating can also comprises pre-validating a file altered by user activity. The user activity can comprise a user function, the user function comprising any one or more of: a cut and paste function, a copy and paste function, a drag and drop function, a send to function, a save as faction, a setup function, a rename file function, and an editing function.

A method of identifying and removing malicious software from a computer system comprising:

A) detecting a plurality of executable files in a hard disk;

B) comparing the executable files to a fingerprint in a source file;

determining if the executable file is new to the system; and
1) if said executable file is not new, verifying if the executable file has been altered;
   a) if the executable file has not been altered, allowing the file to launch;
   b) if the executable file has been altered, removing the file and determining if there is a copy of the unchanged executable file and, if so, replacing altered executable file with the copy of the unchanged file;
2) if said file is new, determining if said file is configured to launch automatically,
   a) removing the executable file from the system if it is configured to launch automatically;
   b) allowing the executable file to launch if the executable file is riot configured to launch automatically.
      The method can further comprise excepting an executable file from removal if the execution file meets a pre-validation criterion. The method can further comprise removing an executable file to a quarantine folder.

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram illustrating a typical operating environment in which malware is detectable in accordance with one aspect of the present invention.

FIG. 2 is a flow diagram illustrating a method of the present invention in which a source file is created as a measure of the previous state of the local computer system.

FIG. 3 is a schematic diagram showing the operation of the overall system in determining whether an executable or script file is a malware.

FIG. 4 is a block diagram illustrating another aspect of the present invention in which reference copies of executable files in the local computer are loaded into the source file.

### DETAILED DESCRIPTION OF THE DRAWINGS

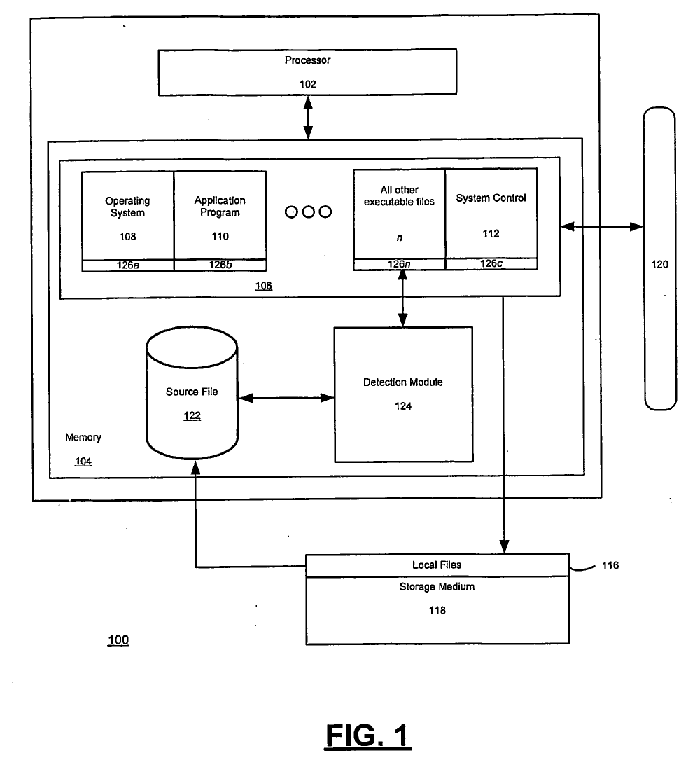

FIG. 1 illustrates a typical operating environment of the present invention on a local computer system. The system 100 on a local computer system comprises a processor 102, memory 104, operating system 108, system control files 112, application programs 110, source file 122 and detection module 124. For purposes of illustrating a representative implementation of the system 100, it is to be understood that executable file 106 may include, but is not limited to, any file with a BAT, EXE, COM, or PE extension that is an application or command file. Similarly, executable file 106 may be any file upon which operating system 108 can take action, as for example, a script file such as a WSF, VBS, ASP or JSP file. Executable files 106, as used herein, includes executable files and their components, because, for example, a macro virus can create and infect a DOT, which is file a template for Word, while no new executable is created (e.g., as when the virus “Redlof.A replaced a blank.htm with its own file). As regards the operating system, the entire operating system is tracked for the presence or absence of changes irrespective of whether files are executable type files or not.

It will be noted by one of ordinary skill in the art that the system 100 recognizes that file types of any extension can be made to run as an executable file. The software product can be configured to identify executable files based on the file extensions, or, because a file with any extension can be made to run as an executable file, if the computer system is so modified, the system can be configured to identify executable files by a reading of the file, not merely the file extension so as to distinguish an executable file from a non-executable file. For example, an executable file can be identified by reading the file header. In this process the header (if it exists, since many other types of files may not necessarily have a header) of each file will be read by the system, and if the file header matches the requirements identifying it as an executable file, then the system will identify it as an executable file and begin its process to identify whether the said executable file satisfies removal criteria. The following examples, as applicable for Microsoft Windows Operating System, demonstrate methods that can be used to identify executable files: “Executable files typically contain a file header at or near the start of the file. This header contains ‘magic numbers’ that identify the file type. Beyond this header, executable files are typically divided into sections. Each section is characterized by name, permissions (RWX), size, file offset, and virtual address (VMA).” (http://my.execpc.com/˜geezer/osd/exec/); “Any executable file must have information the loader expects for an executable file. An executable file must contain Microsoft Windows code and data, or Windows code, data, and resources. Only then will the Windows Operating system recognize it as an executable file.” (http://support.microsoft.com/default.aspx?scid=kb;en-us;65122). In a similar manner, the executable files can be identified in any operating system by reading the files, and validating whether the file has information contained in it that would make it to qualify as an executable file for any other operating system such as Unix, Linux etc.

Executable file 106 may be included with an operating system 108, application program 110, and all other executable file types and their related relevant files. A user of computer typically communicates with executable file 106 and/or local file 116 via user interface 120, which may comprise a keyboard, monitor, mouse, and/or any peripheral computing device.

Executable file 106 is characterized by file properties 126 a-n and may be .exe, .com, or .bat or other file types. File properties 126 may include file information such as file name, file size, file location, path, file creation time (e.g., date and time), and any and/or all other file properties that permit characterization and distinction of one executable file from other executable files. System 100 stores file properties 126 of executable file 106 and all other executables in source file 122 as a fingerprint of the executable file 106. Source file 122 may therefore contain local computer system information like attributes and properties and/or copies of all files a storage device 118 including, but not limited to, operating system 108, application program 110, and system control file 112 and their related files. Cumulative fingerprints included in source file 122 therefore provides state information of a local computer system and all associated files, thereby serving as a reference copy for comparison to status of the computer system at some later point. It is assumed that status of the computer system contained in source file 122 is free of viruses, Trojans, and other malware devices.

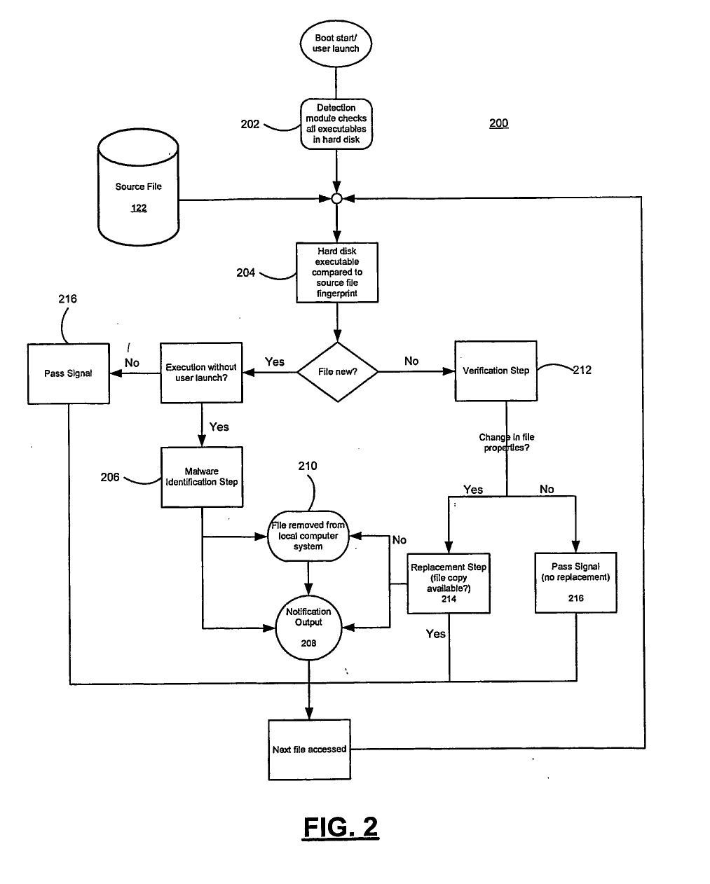

A general survey of the mechanism of system 100 will now be portrayed. A more detailed review of the mechanism is completed in FIGS. 2 through 4, wherein in FIGS. 1 through 2, the same numbers are used to represent the same elements. After boot up, detection module 124 of system 100 reads executable file 106 and operating system 108 and their related files for associated file properties 126. If executable file 106 does not have a corresponding fingerprint in source file 122, then it is validated with reference to the removal criteria to determine if it is malware, and if so removed. If executable file 106 has a correspondingly identical fingerprint in source file 122, then detection module 124 returns a pass signal 216 which is returned to the local computer system. Detection module 124 continues referencing further executable files from the storage medium 118 until all executable files are referenced against a fingerprint in the source file 122. The detection module performs a recursive scan of the hard disk, searching for executable files 106. As soon as it has reached the next executable file 106, the detection module compares the details of the executable file 106 with the source file 122.

The anti-malware system may be configured to move a file that qualifies for removal to a quarantine folder rather than physically removing the file from the storage medium 116. The process of quarantining works as follows: a “Quarantine” folder is created in the storage device (which may be named “Quarantine”). The file that needs to be quarantined is moved into this folder (and removed from its original location). The file thus moved is now renamed taking care to ensure that the name of the extension is such that it is not recognized by the Operating System as an executable file (such as .dat). A quarantine folder refers to any data container that can quarantine the removed executable file.

As shown, the anti-malware system works by comparing executable files 106 on the hard disk with its relevant information stored in the source file 122. The source file 122 is on the hard disk and the executable file 106 being validated is also in the hard disk. Validation of the executable files 106 with reference to its “trigger points” for automatic execution is also accomplished by reading relevant system files on the hard disk, which may include the Registry as well as .ini and other configuration files. The system is not reading the files in the RAM nor does it analyze behavior of files in the RAM. The system, for example its detection module 124 can move to the RAM to execute, and system files and other executable files 106 may be present in the RAM as well. Also, the source file 122 can move to the RAM in order for any Read/Write activity to take place.

Referring now to FIG. 2, a method 200 for identification and removal of the files stored in a local computer system is described. Source file 122 is populated with fingerprints of all files, including executable file 106 and their related files, all files of the operating system 108, and a readable copy of the system control file associated with the computer system. Attributes, properties, and/or copies of all files are stored for reference in source file 122. Detection module 124 checks all executables in the local computer system in system check step 202. One of ordinary skill in the art will understand that system check step 202 can comprise any method for examination of file integrity, including continuous monitoring of FAT configuration, recursive searching using scanning of the local computer system hard disk, tracking a computer log, or any combination thereof. Additionally, it will be understood that upon completion of check step 202, detection module 124 provides a current state of all executable files associated with local computer system which is free of malware up to time of system check step 202. During check step 202, detection module 124 compares present system state in terms of executables, their related files, operating system and its related files with the source file 122 for ensuring that there has been no change in the executable files and their related files, or operating system and its related files. Detection module 124 compares the state of executable file 106 during the system check step 202 with fingerprints of files in source file 122 in comparison step 204. Comparison step 204 can include relating respective file size, file path, file name, and file attributes including date and time and other file properties among the files to be compared. If an executable file is new (that is, if there is not an existing fingerprint entry in source file 122) and is capable of automatic execution without advertent initiation by a user, and has not been created intentionally by the user, detection module 124 identifies the executable file as malware in step 206. The user is notified by notification output 208 and the detection module 124 removes the malware file in removal step 210. It is indisputable that an executable file which has been installed on a local computer system without prior user intervention that is designed for automatic execution during subsequent booting or program launch is a malware.

Similarly, if any file 106 is capable of automatic execution without specific user initiation but detection module 124 matches the file 106 with a fingerprint in source file 122, detection module 124 determines whether there is any change in file 106 and its related files or its properties such as date, time, and other identifying file properties in comparison to the fingerprint in source file 122. If a change in file properties is detected in verification step 212 detection module 124 replaces file 106 with a copy from source file 122 in replacement step 214, if a copy of the file has been stored. In the event that a copy of the file has not been stored, it will remove the file in removal step 210 and notify 208 the user. Because detection module 124 compares file 106 and all associated files, method 200 can address macro viruses and also other viruses that launch automatically upon user launch of an executable file such as an internet browser or email software, such as script viruses.

Where detection module 124 matches the file 106 with a fingerprint in source file 122 during verification step 212, a pass signal 216 is returned to local computer system 100. Detection module 124 continues comparison step 204 in serial fashion with all remaining files and fingerprints in source file 122 until all files are referenced. Subsequently detection module 124 once again restarts step 202, and so on in eternal loop with pre-specified time interval between cycling of the method 200. The pre-specified time interval between cycles of method 200 may be adjusted in accordance with the preference of the user.

In one embodiment the system may include a process filter designed to prevent malicious programs from executing, thereby preventing damage to the computer system from the malicious codes. Normally any request for launch by an executable file, such as happens when a user double clicks the file's icon on the desktop, is processed by the Operating System land the file is launched to the RAM of the computer system for execution. The system may include a hook program that will make the Operating System forward all launch requests by any executable file/program to begin the malware identification process. The system will compare the details of the file creating the launch request with the details present in the source file. If the file's details and the details present in the source file of that file are the same, the Process Filter will return a pass signal, thus permitting the file to proceed to the RAM for execution. And if the file seeking to launch is not present in the source file, the Process Filter will terminate the request for launch, and indicate to the user of the termination.

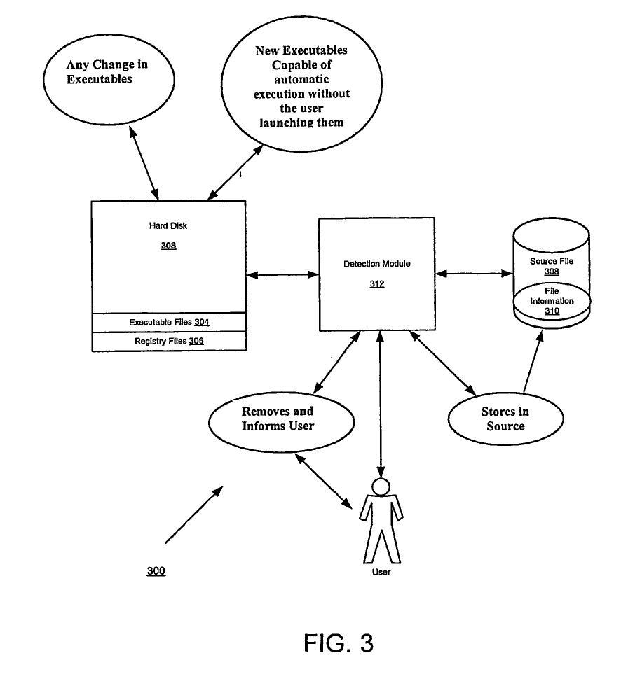

Turning attention to FIG. 3, a schematic diagram illustrates another aspect of the present invention. In a local computer system 302 having executable files 304 and registry files 306 on hard disk 308, an anti-malware system 300 with a detection module 312 is described. Source file 308 contains file information 310 of all executable files 304 and registry files 306 on the local computer system 302. File information 310 derives from local computer system in a state unaffected by malware. Source file 308 thereby provides a reference for continued operation of local computer system 302 free from malware. File information 310 can be stored in database form with associated file names along with properties and values. Alternatively file information 310 can be stored as a copy of the executable files themselves on hard disk 308 of the same local computer system. A further embodiment of system 300 permits file information 310 to be stored on a separate physical storage device. By way of example, storage device may include a drive or partitioned storage device on local computer system 302, a hard disk of another computer on a computer network such as a backup server, external storage device such as a USB drive, or the like. Because a partitioned storage device retains file information for all files in local computer system 302, a partitioned storage device permits facile restoration of computer system 302 within a very small amount of time to the last working state of computer system 302 in the event of a catastrophic system failure such as a hard disk crash or failure of the hardware device.

Operation of anti-malware system 300 will now be described. In local system having changes in executable files 304 and or creation of new executable files, system 300 reads all the files in hard disk 308 for file properties and values. Detection module 312 references the file properties and values of executable files 304 against source file 308. If there is any change in existing executable files 304 or new executable files found (without the user's knowledge and intention) then detection module determines whether the files execute automatically upon booting. If a file matching these criteria are found, the file is identified as malware, the file is deleted and the user is informed. If there is any change in existing executable files 304 or new executables found, and if prior to the detection module 312 discovering this, the user has specifically indicated his proposed activity of installing new software in the computer system, then the anti-malware system will accept the new executables which are not configured to execute automatically as valid executables and store the information on these executables in source file 308, and confirm with the user before removing the new executables which are configured to execute automatically upon booting.

In one embodiment, the system may also accept certain kinds of files as user created/pre-validated files, even if the user has not specifically indicated that he or she will be installing new software. These files include files created by the following exemplary activities:
(i) “Cut and Paste”, “Copy and Paste”, “Drag and Drop”, “Send To”, “Rename” for files which are already present in the source file, and/or of folders containing files which are already present in the source file.
(ii) “Cut and Paste”, “Copy and Paste”, “Drag and Drop”, and “Send To” of files from an external media (for example, remote storage devices such as CD from the CD drive of the local computer system, USB and flash memory devices/drives, or floppy from the floppy drive of the local computer system etc.) whereby it is apparent that these have been created by the user due to the human action of inserting the CD or floppy in the drive, or by inserting the USB/flash device.
(iii) Using the “Save As” command, (it being understood that a User has used the Save As feature to create the new file in the computer system).
(iv) Automatic Online Updates of software existing in the system which are present in the source file, so long as the process responsible for the automatic online updates and creating the new files is present in the source file, without any tampering or changes, and it is clearly identified that the new files created have been created out of the normal activity of this process only.
(v) Files arising out of a “Setup” file, so long as the Setup file is from an external media such as CD, floppy, USB/flash device, or is already present in the source file, or has been downloaded from the internet and has been validated by the user as a valid file that he has downloaded, either by means of a positive confirmation to the anti-malware system or by using the “Save As” feature described above.

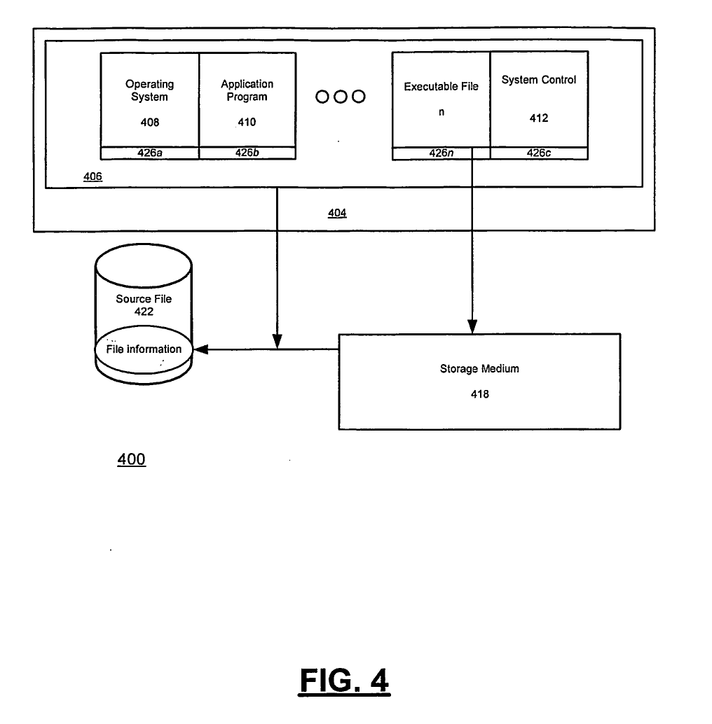

Referring now to FIG. 4, the creation of a source file 422 in anti-malware system 400 will now be described. Items in memory 404 may include operating system files 408, application programs 410, system control files 412, and other files including executable files 406. Each of said files has file properties; as for example, file properties 426 a-c. The local computer system on which system 400 operates, including files resident therein and their associated components is presumed to be free of malware. Source file 422 retains a database of all file properties of the above files and/or a copy of the files which are moved into storage medium 418. Source file 422 therefore contains local computer system information like attributes and properties and/or copies of all files in including, but not limited to, operating system 408, application program 410 and all other executable files, and a copy of the system control file 412 and their related files.

While certain embodiments have been described and shown in the accompanying drawings, it is to be understood that such embodiments are merely illustrative of, and not restrictive on, the broad invention. Other embodiments that are apparent to those of ordinary skill in the art, including embodiments that do not provide all of the features and advantages set forth herein, are also within the scope of this invention. By way of example, whereas the aforementioned system is capable of eradicating malware executables, the system adequately addresses macro viruses which infect DOT files associated with templates for .doc files. Additionally, the system addresses any change to an operating system global environment of a local computer system irrespective of whether the changes in file properties are associated with executable files types or not. Because global changes are tracked by comparison of local computer system properties to a source file, the system is independent of the client and platform on which it runs. Therefore, the system is apposite for malware intervention on any platform including Windows OS, Sun Unix, and the like.

This invention is not limited to the specific construction and arrangements shown and described as various modifications or changes may occur to those of ordinary skill in the art without departing from the spirit and scope of the invention. It should be understood that the above description is only representative of illustrative embodiments. For the convenience of the reader, the above description has focused on a limited number of representative samples of all possible embodiments, samples that teach the principles of the invention. The description has not attempted to exhaustively enumerate all possible variations or even combinations of those variations described. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments, involve differences in technology rather than differences in the application of the principles of the invention. It will be recognized that, based upon the description herein, most of the principles of the invention will be transferable to other specific technology for implementation purposes. This is particularly the case when the technology differences involve different specific hardware and/or software. Accordingly, the invention is not intended to be limited to less than the scope set forth in the following claims and equivalents.

1. A system for identifying and removing malicious software from a computer system including a processor and memory comprising:
a storage medium comprising an executable file;
a detection module;
a removal criterion;
wherein said detection module is configured to remove the executable file if the detection module determines that the executable file meets the removal criterion.

2. The system of claim 1 wherein the system further comprises:
a source file comprising a stored file information identifying a malware-free state of said computer system.

3. The system of claim 2 wherein the stored file information further comprises:
a stored copy of a malware-free executable file.

4. The system of claim 2 wherein the stored file information comprises:
a fingerprint including information about a malware-free execution file.

5. The system of claim 2 wherein the detection module is configured to scan the executable file and send a pass signal if said executable file matches the stored filed information.

6. The system of claim 5 wherein the detection module is configured to scan the executable file for an executable file property associated with said executable file and send a pass signal if said executable file property matches the fingerprint.

7. The system of claim 5 wherein the detection module is configured to read the executable file send a pass signal if said executable file matches a stored copy of the malware-free executable file.

8. The system of claim 4 wherein the detection module continues scanning the executable files in a storage medium until all executable files are referenced against said fingerprint in said source file.

9. The system of claim 2 wherein the removal criterion comprises:
removing the executable file when said executable file does not correspond to the stored information.

10. The system of claim 9 wherein the removal criterion comprises removing the executable file when said executable file is configured to automatically execute without user approval.

11. The system of claim 10 wherein the removal criterion comprises:
requiring confirmation before removing the executable file.

12. The system of claim 3 wherein the stored file information includes the copy of the malware-free executable file on a remote storage device.

13. The system of claim 2 wherein the detection module:
scans the executable file;
compares the executable file with the stored file information to determine if the executable file meets the removal criterion; and
removes the executable file that meets the removal criteria.

14. The system of claim 1 wherein the removal criterion comprises:
removing the executable file, said executable file being operatively related to an instruction to automatically launch the executable file.

15. The system of claim 14 wherein the detection module is configured to read said system's files for the instruction to automatically launch the executable file, said system's files including system control files and configuration files.

16. The system of claim 9 wherein the system further comprises:
a process filter, said process filter configured to prevent the executable file from launching to a Random Access Memory if said executable file does not correspond to the stored information.

17. The system of claim 1 wherein the system further comprises:
a pre-validation criterion, wherein the executable file meeting the pre-validation criterion will not be subject to removal via the removal criteria.

18. The system of claim 17 wherein the pre-validation criterion comprises:
the executable file is a function of an automatic update.

19. The system of claim 17 wherein the pre-validation criterion comprises:
the executable file is effected as a function of user activity.

20. The system of claim 19 wherein the user activity comprises a user function, the user function selected from comprising any one or more of:
a cut and paste function;
a copy and paste function;
a drag and drop function;
a send to function;
a save as faction;
a setup function;
a rename file function; and
an editing function.

21. A method for identifying and removing malicious software from a computer system comprising:
storing information about a state of a computer system, said state being free of malware;
detecting an executable file in said computer system;
comparing the executable file with the stored information;
determining if the executable file matches the stored information;
sending a pass signal if said executable file matches the corresponding stored information; and
removing said executable file when said executable file does not match the corresponding stored information.

22. The method of claim 21, wherein the stored information comprises a fingerprint, said fingerprint including identifying information about malware-free execution files.

23. The method of claim 21 wherein said stored information includes copies of a malware-free executable file in a storage medium.

24. The method of claim 22 wherein said fingerprint includes:
a plurality of fingerprints.

25. The method of claim 21 wherein the detecting comprises any one or more of:
continuous monitoring of FAT configuration;
recursive searching using scanning of the local computer system hard disk;
searching for an event trigger upon saving a file to a storage medium of the computer system; and
tracking a computer log.

26. The method of claim 21 wherein the detecting further comprises:
updating the state of a local computer system, the state being free of malware.

27. The method of claim 21 wherein the comparing the executable file further comprises comparing a file attribute, said file attribute comprising one or more of:
a respective file size;
a file path;
a file creation time; and
a file name.

28. The method of claim 21 wherein removing comprises:
removing the executable file when the file was not created intentionally by a user; and
notifying the user via a notification output that the file was removed as malware.

29. The method of claim 23 wherein method comprises:
comparing the executable file with the stored information;
determining, via the detection module, whether there is any difference between the executable file and the stored information; and
if there is the difference, replacing said removed executable file with the copy of the stored malware-free executable file.

30. The method of claim 21 wherein the malicious software includes:
a virus that launches automatically upon a launch of the executable file.

31. The method of claim 24 wherein the method further comprises:
repeating the comparing until all executable files are compared to the fingerprints.

32. The method of claim 21 wherein detecting comprises:
determining if the executable files are configured to execute automatically.

33. The method of claim 21 wherein the method comprises:
indicating that new software is to be installed on the computer system; and
a) accepting an executable file that is not identical to the stored information as a function of the indication, if said executable file not configured to execute automatically; or
b) accepting a removal confirmation prior to removing an executable file if said file is configured to execute automatically.

34. The system of claim 1 wherein the executable file is operatively connected to a related component program; and
wherein said detection module is configured to remove the executable file and the related component program if the detection module determines that the executable file meets the removal criterion.

35. The method of claim 21 wherein the detecting further comprises:
detecting an executable file operatively connected to a related component program in said computer system;
determining if the executable file and the related component program matches said stored information;
sending a pass signal if said executable file and the related component program has the corresponding stored information; and
removing said executable file and the related component program when said executable file does not have the corresponding stored information.

36. The method of claim 21 wherein the method further comprises:
preventing the executable file from launching to a Random Access Memory if said executable file property does not correspond to the fingerprint in the source file.

38. The method of claim 21 wherein the method further comprises:
pre-validating the executable file such that it will not be subject to removal via the removal criteria.

39. The method of claim 38 wherein the pre-validating comprises pre-validating the executable file as a function of an automatic update.

40. The method of claim 39 wherein the pre-validating comprises:
pre-validating a file altered by user activity.

41. The method of claim 41 wherein the user activity comprises a user function, the user function comprising any one or more of:
a cut and paste function;
a copy and paste function;
a drag and drop function;
a send to function;
a save as faction;
a setup function;
a rename file function; and
an editing function.

42. The system of claim 1 wherein the system further comprises:
a quarantine folder;
wherein the executable file is removed to the quarantine folder if the executable file meets the removal criterion.

43. The method of claim 21 wherein the removing comprises:
removing the executable to a quarantine folder.

44. A method of identifying and removing malicious software from a computer system comprising:
A) detecting a plurality of executable files in a hard disk;
B) comparing the executable files to a fingerprint in a source file;
determining if the executable file is new to the system; and
1) if said executable file is not new, verifying if the executable file has been altered;
a) if the executable file has not been altered, allowing the file to launch;
b) if the executable file has been altered, removing the file and determining if there is a copy of the unchanged executable file and, if so, replacing altered executable file with the copy of the unchanged file;
2) if said file is new, determining if said file is configured to launch automatically;
a) removing the executable file from the system if it is configured to launch automatically;
b) allowing the executable file to launch if the executable file is not configured to launch automatically.

45. The method of claim 44 wherein the method further comprises:
excepting an executable file from removal if the execution file meets a pre-validation criterion.

46. The method of claim 44 wherein the method further comprises:
removing an executable file to a quarantine folder.

47. The system of claim 1 wherein the computer system comprises:
a handheld computer device;
a laptop computer device;
a cell-phone;
a personal digital assistant; or
a desktop computer.
